(19) United States
(12) Patent Application Publication
(10) Pub. No.: US 2026/0057133 A1
(43) Pub. Date: Feb. 26, 2026

(54) GENERATING MECHANICAL ASSEMBLIES USING HYBRID SEARCH ALGORITHMS AND TRANSFORMER MODELS

(71) Applicant: AUTODESK, INC., San Francisco, CA (US)

(72) Inventors: Hyunmin CHEONG, Toronto (CA); Yasaman ETESAM, Vancouver (CA); Mohammadmehdi ATAEI, Toronto (CA); Pradeep Kumar JAYARAMAN, Toronto (CA)

(21) Appl. No.: 19/264,442

(22) Filed: Jul. 9, 2025

Related U.S. Application Data
(60) Provisional application No. 63/686,111, filed on Aug. 22, 2024.

(51) Int. Cl. G06F 30/17; G06F 30/27; G06F 111/04; G06F 111/20

(52) U.S. Cl. CPC G06F 30/17; G06F 30/27; G06F 2111/04; G06F 2111/20

(57) ABSTRACT

A computer-implemented method is disclosed for generating mechanical assemblies using iterative optimization and generative artificial intelligence (AI). The method includes receiving a mechanical parts catalog and assembly requirements, and executing an iterative generation process. The process comprises generating, via limited sampling, at least one combined mechanical assembly that may satisfy the requirements; generating, via a generative AI model, at least one complete mechanical assembly based on the combined assembly and the requirements; and generating assembly metrics by applying at least one physics simulation to the complete assembly. A reward score is generated based on the assembly metrics, and the iterative generation process is repeated based on the reward score until a convergence threshold is satisfied. The method further includes performing at least one operation associated with the complete mechanical assembly.

### CROSS-REFERENCE TO RELATED APPLICATIONS

The present application claims the benefit of U.S. Provisional Application titled, “INTEGRATING DEEP GENERATIVE MODELS WITH SEARCH TECHNIQUES TO RESOLVE MECHANICAL CONFIGURATION DESIGN PROBLEMS,” filed on Aug. 22, 2024, and having Ser. No. 63/686,111. The subject matter of this related application is hereby incorporated herein by reference.

### BACKGROUND

### Field of the Various Embodiments

Embodiments of the present disclosure relate generally to computer science, artificial intelligence, and mechanical system design, and, more specifically, to generating mechanical assemblies using hybrid search algorithms and transformer models.

### Description of the Related Art

Mechanical system design is a multidisciplinary process that incorporates principles from engineering, optimization, and computational modeling. A typical design effort requires integration of diverse physical components-such as actuators, brackets, sensors, and structural elements-into a cohesive, functional system. Components often originate from different manufacturers and vary widely in shape, size, specification, and interface characteristics. Assembling a complete system requires satisfaction of both system-level constraints—such as volume, weight, cost, manufacturability, and regulatory compliance—as well as component-level constraints, including mechanical tolerances, spatial compatibility, and performance limitations. The resulting design space is complex, highly constrained, and frequently non-intuitive, thereby creating a significant need for computational tools that can support efficient and informed design decisions.

Conventional automated design techniques typically approach mechanical system design as a combinatorial optimization task. In this framework, the design process involves selecting and arranging discrete component options such that the resulting configuration satisfies all applicable constraints while optimizing for one or more objective functions, such as performance, efficiency, or cost. A variety of algorithmic strategies have been employed for this purpose, including evolutionary algorithms, simulated annealing, and Monte Carlo tree search. Each candidate configuration can undergo evaluation using physics-based simulations, which serve as black-box evaluators for assessing compliance with structural, functional, and performance requirements.

One drawback of conventional automated design techniques is the limited capability to efficiently identify functional solutions for complex mechanical systems. As mechanical system complexity increases—particularly for designs involving numerous interdependent components operating in sequence—the solution space grows exponentially. Full exploration of the solution space to uncover viable configurations can therefore become computationally intensive and impractical. In that regard, achieving a productive balance between global exploration and local refinement typically requires extensive manual tuning of algorithmic parameters, which in turn demands significant domain expertise. Even with expert intervention, automated design techniques may fail to yield functional or feasible configurations, particularly when navigating multi-objective or highly constrained design spaces.

Another drawback of conventional automated design techniques is lack of interactivity during the design process. In particular, conventional systems generally function as closed-loop processes, and generate complete design proposals without exposing intermediate results or allowing user intervention during the process. The absence of interactivity limits designer ability to steer the process, incorporate domain-specific insights, or dynamically adjust constraints in response to emerging design tradeoffs. In that regard, the lack of iterative exploration, real-time collaboration, and rapid prototyping reduces practical utility in real-world engineering workflows.

Accordingly, a need exists for improved techniques that more effectively and interactively support the generation of complex mechanical system designs.

### SUMMARY

One embodiment sets forth a computer-implemented method for generating mechanical assemblies. According to some embodiments, the method includes the steps of receiving a mechanical parts catalog and assembly requirements for a mechanical assembly; and executing an iterative mechanical assembly generation process comprising: generating, via a limited sampling of the mechanical parts catalog, at least one combined mechanical assembly, wherein the at least one combined mechanical assembly potentially satisfies the assembly requirements; generating, via a generative artificial intelligence (AI) model, at least one complete mechanical assembly based on the at least one combined mechanical assembly and the assembly requirements; generating assembly metrics based on at least one physics simulation applied to the at least one complete mechanical assembly; generating a reward score based on the assembly metrics; and repeating the iterative mechanical assembly generation process based on the reward score until a convergence threshold associated with the generative AI model is satisfied; and performing at least one operation associated with the at least one complete mechanical assembly.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques over the prior art is that the disclosed techniques combine the strengths of distinct methodologies to address complex mechanical design challenges. Traditional design techniques can be effective at generating a range of candidate solutions, but often struggle to converge on optimal or high-quality solutions when faced with intricate design constraints. In contrast, transformer-based models can generate solutions with exceptional speed, yet often lack the capacity to explore the broader space of creative or unconventional alternatives. The disclosed techniques integrate these complementary capabilities, using the generative efficiency of transformer-based models to rapidly produce candidate solutions while leveraging exploratory methods to more fully traverse the design space. As a result, the techniques can identify and synthesize comprehensive solutions that account for both structural feasibility and design intent. Another technical advantage is the support for interactive and iterative design workflows. By enabling the sampling of complete mechanical system configurations from partially specified inputs, the disclosed techniques allow designers to explore multiple viable design alternatives without restarting the design cycle. This interactivity further enables the real-time incorporation of domain-specific knowledge and user feedback directly into the generative process, leading to more effective, tailored design outcomes.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of various embodiments.

FIG. 2 is a block diagram illustrating the computing device of FIG. 1 in greater detail, according to various embodiments.

FIG. 3 is a conceptual illustration of an architecture and an informational flow that can be implemented by the hybrid mechanical design application of FIG. 1, according to various embodiments.

FIG. 4 is a more detailed illustration of the deep transformer model of FIG. 3, according to various embodiments

FIG. 5 illustrates a method for automated mechanical system design, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

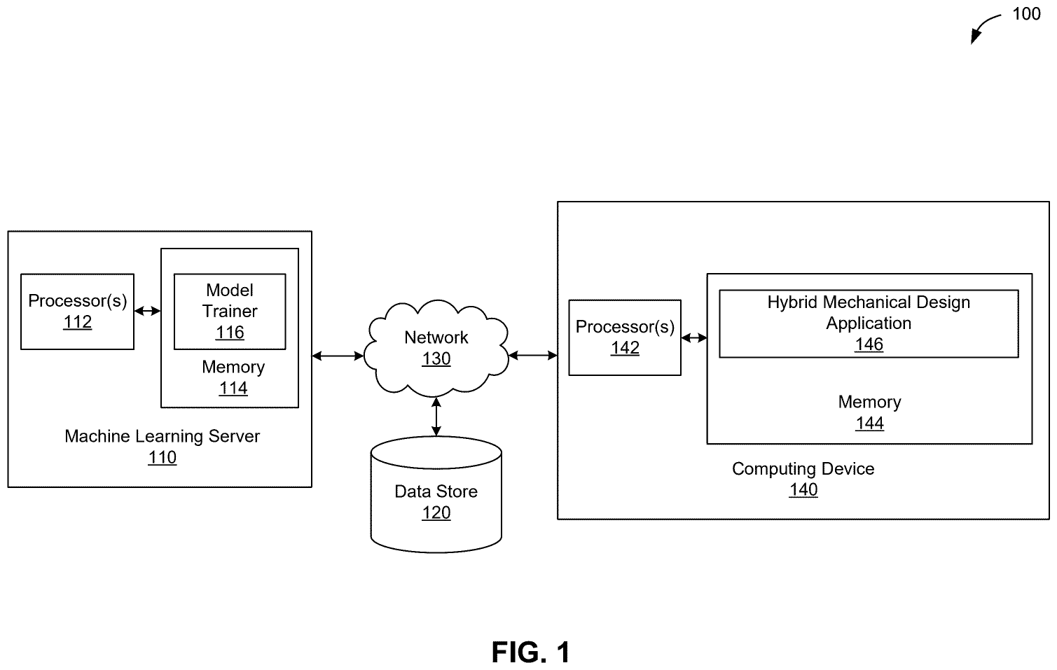

FIG. 1 illustrates a block diagram of a computer-based system 100 configured to implement one or more aspects of the various embodiments. As shown, the system 100 includes, without limitation, a machine learning server 110, a data store 120, and a computing device 140 in communication over a network 130. The network 130 can be a wide area network (WAN) such as the internet, a local area network (LAN), a cellular network, and/or any other suitable network.

As also shown, a model trainer 116 executes on one or more processors 112 of the machine learning server 110 and is stored in a system memory 114 of the machine learning server 110. The one or more processors 112 receive user input from input devices, such as a keyboard or a mouse. In operation, the one or more processors 112 may include one or more primary processors of the machine learning server 110, which control and coordinate operations of other system components. In particular, the processor(s) 112 can issue commands that control the operation of one or more graphics processing units (GPUs) (not shown) and/or other parallel processing circuitry, such as parallel processing units or deep learning accelerators, that incorporate circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or flash ROM), or any suitable combination of the foregoing. In some embodiments, a storage (not shown) can supplement or replace the system memory 114. The storage can include any number and type of external memories accessible to the processor 112 and/or the GPU. For example, and without limitation, the storage can include a secure digital card, an external flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment. Such an environment can be a public, private, or a hybrid cloud system.

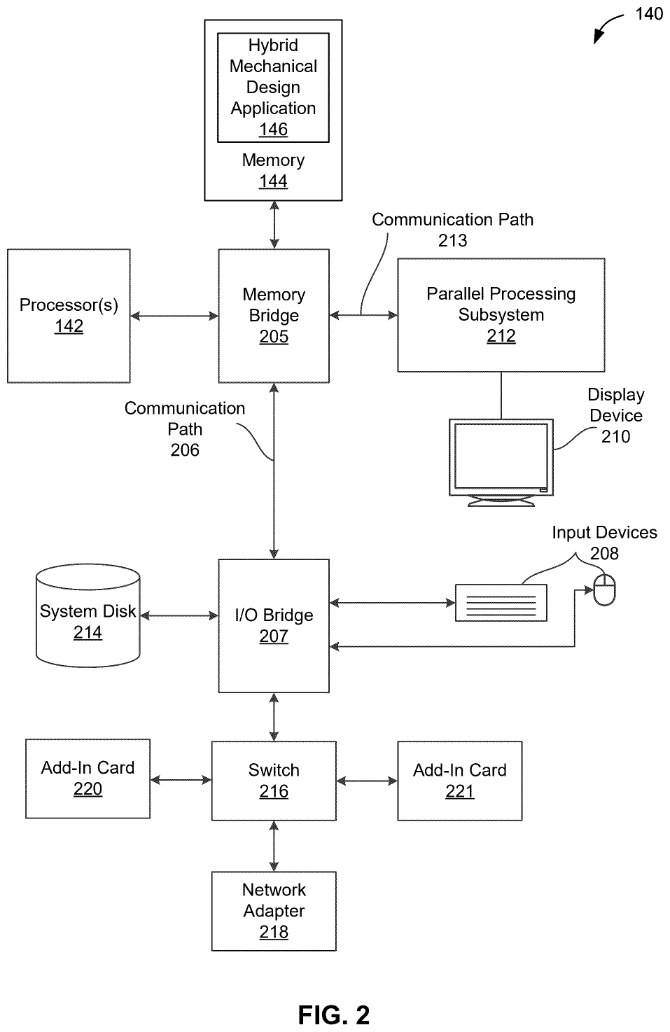

In some embodiments, the model trainer 116 is configured to train one or more machine learning models, including an assembly transformer model 148. Techniques that the model trainer 116 can use to train the machine learning model(s) are discussed in greater detail below in conjunction with FIGS. 2-5. Training data and/or trained (or deployed) machine learning models, including data generated by a hybrid mechanical design application 146, can be stored in the data store 120. In some embodiments, the data store 120 can include any storage device or devices, such as fixed disc drives, flash drives, optical storage, network attached storage (NAS), and/or a storage area-network (SAN). Although shown as accessible over the network 130, in at least one embodiment, the machine learning server 110 can include the data store 120.

FIG. 2 is a block diagram illustrating the computing device 140 of FIG. 1 in greater detail, according to various embodiments. Computing device 140 may be any type of computing system, including, without limitation, a server machine, a server platform, a desktop machine, a laptop machine, a handheld/mobile device, a digital kiosk, or a wearable device. In some embodiments, computing device 140 is a server machine operating in a data center or a cloud computing environment that provides scalable computing resources as a service over a network.

In various embodiments, computing device 140 includes, without limitation, the processor(s) 142 and the memory(ies) 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, computing device 140 may be a server machine in a cloud computing environment. In such embodiments, computing device 140 may not include input devices 208 but may receive equivalent input information by receiving commands (e.g., responsive to one or more inputs from a remote computing device) in the form of messages transmitted over a network and received via the network adapter 218. In some embodiments, switch 216 is configured to provide connections between I/O bridge 207 and other components of the computing device 140, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-rom), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a northbridge chip, and I/O bridge 207 may be a southbridge chip. In addition, communication paths 206 and 213, as well as other communication paths within computing device 140, may be implemented using any technically suitable protocols, including, without limitation, AGP (accelerated graphics port), hypertransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212. In various embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on a chip (SoC).

System memory 144 includes at least one device driver configured to manage the processing operations of the one or more PPUs within parallel processing subsystem 212. In addition, the system memory 144 includes the hybrid mechanical design application 146. Although described herein primarily with respect to the hybrid mechanical design application 146, techniques disclosed herein can also be implemented, either entirely or in part, in other software and/or hardware, such as in the parallel processing subsystem 212.

In some embodiments, processor(s) 142 includes the primary processor of computing device 140, controlling and coordinating operations of other system components. In some embodiments, the processor(s) 142 issues commands that control the operation of PPUs. In some embodiments, communication path 213 is a PCI express link, in which dedicated lanes are allocated to each PPU. Other communication paths may also be used. The PPU advantageously implements a highly parallel processing architecture, and the PPU may be provided with any amount of local parallel processing memory.

It will be appreciated that the system shown herein is illustrative and that variations and modifications are possible. The connection topology, including the number and arrangement of bridges or the number of parallel processing subsystems 212, may be modified as desired. For example, in some embodiments, system memory 144 could be connected to the processor(s) 142 directly rather than through memory bridge 205, and other devices may communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (VPU(s)) that renders graphics on a virtual machine(s) (VM(s)) executing on a server machine(s) whose GPU(s) and other physical resources are shared across one or more VMs.

### Hybrid Automated Design Systems

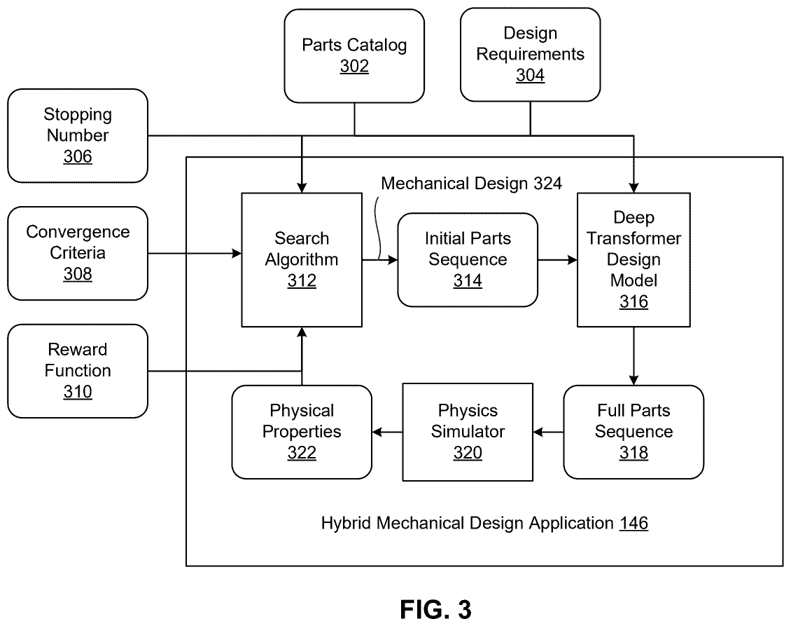

FIG. 3 provides a detailed illustration of the hybrid mechanical design application 146 described in conjunction with FIG. 1, according to various embodiments. As shown in FIG. 3, the hybrid mechanical design application 146 includes a search algorithm 312, a deep transformer design model 316, and a physics simulator 320. In some embodiments, the search algorithm 312, the deep transformer design model 316, and the physics simulator 320 operate sequentially to generate a mechanical design 324 from a parts catalog 302, design requirements 304, a stopping number 306, a convergence criteria 308, and a reward function 310.

In some embodiments, the parts catalog 302 consists of a collection of mechanical parts—such as digital representations of gears, shafts, etc.—available to a designer for use in a specific mechanical assembly design. It is noted that the foregoing examples are not meant to be limiting, and that the parts catalog 302 can include any number, type, form, etc., of parts, at any level of granularity, consistent with the scope of this disclosure. In some embodiments, such parts can be connected in various ways and orientations to generate mechanical assembly designs that perform mechanical tasks.

In some embodiments, the design requirements 304 include a list of constraints to which the mechanical design 324 must adhere. For example, in some embodiments, the design requirements 304 specify constraints such as the maximum volume, weight, and monetary cost of the mechanical design 324. It is noted that the foregoing examples are not meant to be limiting, and that the design requirements 304 can include any number, type, form, etc., of constraint(s), at any level of granularity, consistent with the scope of this disclosure.

In some embodiments, the stopping number 306 defines the maximum depth to which the search algorithm 312 searches while generating an initial parts sequence 314. The search algorithm 312 selects parts from the parts catalog 302 and creates a parts sequence to satisfy the design requirements 304 until the number of parts is equal to the stopping number 306, at which point the parts sequence is returned as the initial parts sequence 314.

The convergence criteria 308 defines a procedure for ceasing iteration of the search algorithm 312. When convergence criteria 308 is met, hybrid mechanical design application 146 ceases iteration and returns the mechanical design 324. For example, in some embodiments, a convergence criteria 308 indicates a fixed number of iterations to be performed. In other embodiments, a convergence criteria 308 is defined based on the specific search algorithm 312 being implemented.

In some embodiments, the reward function 310 defines a measure of the quality of a full parts sequence 318 based on the outputs of the physics simulator 320. For example, in some embodiments, the reward function 310 specifies a procedure for assessing the combination of the weight, volume, and monetary cost of full parts sequence 318, where a lower overall score indicates a more desirable mechanical design 324. It is noted that the foregoing examples are not meant to be limiting, and that the reward function 310 can include any number, type, form, etc., of reward(s), at any level of granularity, consistent with the scope of this disclosure.

In some embodiments, the search algorithm 312 receives the parts catalog 302, the design requirements 304, the stopping number 306, the convergence criteria 308, and the reward function 310 as input and generates initial parts sequence 314 as output. In some embodiments, the implementation of the search algorithm 312 addresses combinatorial optimization problems within the space of mechanical system designs. The search algorithm 312 performs a search procedure to identify valid mechanical system designs according to the design requirements 304. In some embodiments, algorithms such as Monte Carlo tree search or estimation of distribution algorithm may be used. It is noted that the foregoing examples are not meant to be limiting, and that the search algorithm 312 can implement any number, type, form, etc., of search algorithm(s), at any level of granularity, consistent with the scope of this disclosure.

In some embodiments, the search algorithm 312 selects components from the parts catalog 302 to meet the criteria of the design requirements 304 to maximize reward function 310. In some embodiments, if a Monte Carlo tree search is used as the search algorithm 312, then the reward function 310 is a heuristic that combines the average reward value for the selected combination of components and a term that prompts further exploration of other component part sequences that have not yet been explored. Upon assembling a parts sequence with a number of components that matches stopping number 306, the search algorithm 312 ceases operations and returns the assembled parts sequence as the initial parts sequence 314.

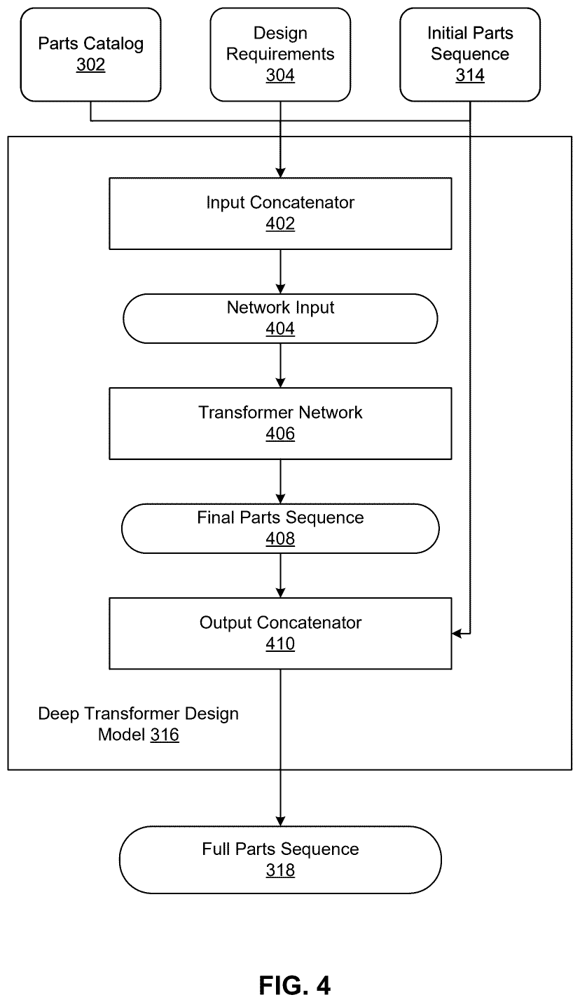

In some embodiments, the deep transformer design model 316 receives the parts catalog 302, the design requirements 304, and the initial parts sequence 314 as inputs to generate a full parts sequence 318 as an output. As described in greater detail below in conjunction with FIG. 4, in some embodiments, the deep transformer design model 316 is a transformer model trained to interpret the requirements indicated by the design requirements 304. In some embodiments, the deep transformer design model 316 generates token sequences that correspond to the components in the parts catalog 302 that fulfill the design requirements 304. In some embodiments, the deep transformer design model 316 receives the initial parts sequence 314 as input, alongside the design requirements 304, and generates tokens to complete a comprehensive parts sequence. The comprehensive parts sequence, which satisfies the design requirements 304, is then returned as a full parts sequence 318.

In some embodiments, the physics simulator 320 accepts the full parts sequence 318 and generates the physical properties 322 as output. According to some embodiments, the physics simulator 320 is implemented as a black-box physics simulator that simulates the properties of full parts sequence 318. For example, in some embodiments, the physics simulator 320 determines the torque, weight, and other related properties necessary to compute the reward function 310. It is noted that the foregoing examples are not meant to be limiting, and that the physics simulator 320 can implement any number, type, form, etc., of physical property simulations, at any level of granularity, consistent with the scope of this disclosure. The physical properties 322 are returned to the search algorithm 312 and used with the reward function 310 to update the search heuristics of the search algorithm 312.

The hybrid mechanical design application 146 continues the search procedure following the algorithm defined by the search algorithm 312 until the convergence criteria 308 is met. For example, in some embodiments, the convergence criteria 308 is the number of iterations of the search procedure to perform until ceasing and returning the mechanical design 324. It is noted that the foregoing examples are not meant to be limiting, and that the convergence criteria can implement any number, type, form, etc., of criteria, at any level of granularity, consistent with the scope of this disclosure.

After a convergence criteria 308 is met, the search algorithm 312 returns a mechanical design 324. The search algorithm 312 defines a procedure to select the mechanical design 324 from the performed search procedure. For example, in some embodiments, a mechanical design 324 is the full parts sequence 318 that generated the maximum value of reward function 310. In other embodiments, a mechanical design 324 is a list of various full parts sequence 318 values along with the corresponding values of reward function 310.

FIG. 4 provides a more detailed description of the deep transformer design model 316 discussed above in conjunction with FIG. 3, according to various embodiments. As shown, the deep transformer design model 316 consists of an input concatenator 402, a transformer network 406, and an output concatenator 410 that operate to generate a full parts sequence 318.

In some embodiments, the input concatenator 402 receives the parts catalog 302, the design requirements 304, and the initial parts sequence 314 as input and generates the network input 404 as output. The input concatenator 402 concatenates the parts catalog 302, the design requirements 304, and the initial parts sequence 314 into a single input token stream compatible with the transformer network 406. In some embodiments, the input concatenator 402 combines the design requirements 304 and the initial parts sequence 314 into a single input sequence. In some embodiments, the parts catalog 302 is also prepended to the input sequence to provide the transformer network 406 additional context of parts that are available for the use in the mechanical design 324. In other embodiments, the transformer network has been pre-trained with knowledge of valid parts, and the parts catalog 302 is not included in the input sequence. The input sequence is returned as the network input 404.

In some embodiments, the transformer network 406 accepts the network input 404 as input and generates the final parts sequence 408 as output. In some embodiments, the transformer network 406 is a neural network model with a transformer model architecture trained to generate a sequence of output tokens that follow a provided sequence of input tokens. Specifically, the transformer network 406 can be trained to generate a sequence of parts from the parts catalog 302 that will satisfy the design requirements 304. As a consequence of the training, the transformer network can also generate the remaining parts in a sequence when provided the design requirements 304 and an initial parts sequence 314. The generated sequence is returned as the final parts sequence 408.

In some embodiments, the output concatenator 410 accepts the initial parts sequence 314 and the final parts sequence 408 as input and generates the final parts sequence 318 as output. The output concatenator 410 combines the parts from the initial parts sequence 314 and the final parts sequence 408 into a single sequence. The complete sequence is returned as the full parts sequence 318.

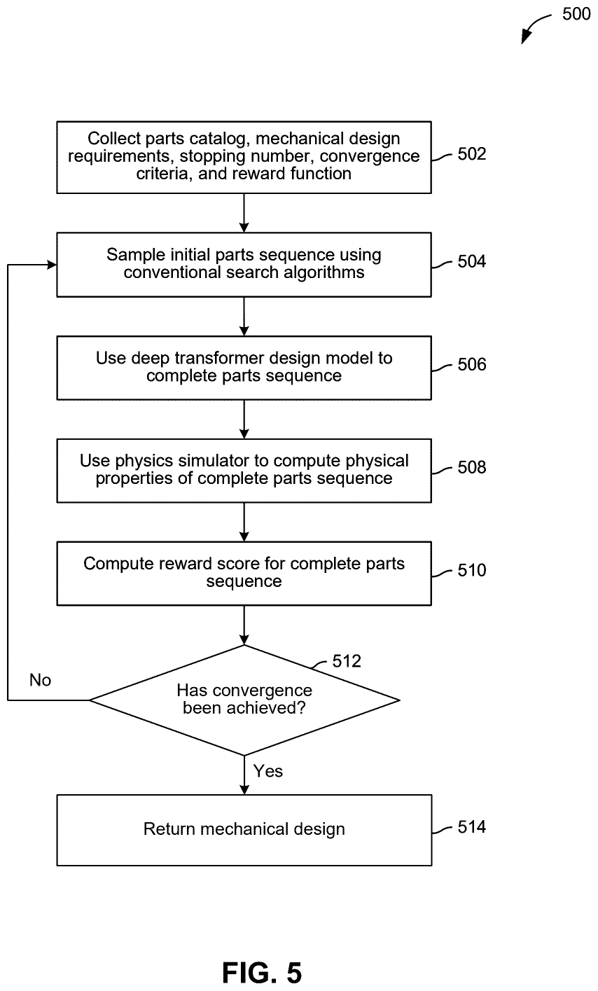

FIG. 5 sets forth a flow diagram of method steps for automated mechanical system design using hybrid search techniques, according to various embodiments. Although the method steps are described in conjunction with the systems of FIGS. 1-4, persons skilled in the art will understand that any system configured to perform the method steps in any order falls within the scope of the present disclosure.

As shown, method 500 begins at step 502, where the hybrid mechanical design application 146 receives the parts catalog 302, the design requirements 304, the stopping number 306, the convergence criteria 308, and the reward function 310 for processing to generate the mechanical design 324.

At step 504, the search algorithm 312 uses the parts catalog 302, the design requirements 304, the stopping number 306, the convergence criteria 308, and the reward function 310 to generate the initial parts sequence 314, which addresses combinatorial optimization problems within the space of mechanical system designs. The search algorithm 312 selects components from the parts catalog 302 to meet the criteria of the design requirements 304 to maximize the reward function 310. Upon assembling a parts sequence with a number of components that matches the stopping number 306, the search algorithm 312 ceases operations and returns the assembled parts sequence as the initial parts sequence 314. For example, in some embodiments, if Monte Carlo tree search is used for the search algorithm 312, the algorithm samples parts in sequence from the parts catalog 302 using a heuristic. The heuristic balances exploration of new pathways with observed score from reward function 310 from previous visits to existing pathways. The search algorithm 312 samples parts to a depth equal to the stopping number 306, at which point the initial parts sequence 314 is returned.

At step 506, the deep transformer design model 316 uses the parts catalog 302, the design requirements 304, and the initial parts sequence 314 as input to generate a full parts sequence 318 as an output. In some embodiments, the deep transformer design model 316 receives the initial parts sequence 314 as input, alongside the design requirements 304, and generates tokens to complete a comprehensive parts sequence. The comprehensive parts sequence, which satisfies the design requirements 304, is then returned as a full parts sequence 318. For example, in some embodiments, the deep transformer design model 316 receives an input defining the maximum volume and weight of a particular design along with the list of initial parts sequence 314. The deep transformer design model 316 generates the full parts sequence 318 that completes the initial parts sequence 314 and satisfies the design criteria 304.

At step 508, the physics simulator 320 receives the full parts sequence 318 as input to generate the physical properties 322 as output. The physics simulator 320 is implemented as a black-box physics simulator that simulates the properties of full parts sequence 318. For example, in some embodiments, the physics simulator 320 determines the torque, weight, and other related properties necessary to compute reward function 310. The physics simulator 320 returns these properties as the physical properties 322. For example, in some embodiments, the physics simulator 320 assesses weight and volume properties of the full parts sequence 318.

At step 510, the physical properties 322 are used to compute the value of the reward function 310 for the full parts sequence 318. The reward function 310 generates higher values if the full parts sequence 318 has preferable values for the physical properties 322. For example, in some embodiments, the reward function 310 may provide higher values if the full parts sequence has a low weight or fewer total parts. The value from the reward function 310 is then used to update the search procedure of the search algorithm 312. For example, in some embodiments, if Monte Carlo tree search is used as the search algorithm 312, then the reward scores from the reward function 310 are propagated back up the search tree and each node is updated up to the root node.

At step 512, the convergence criteria 308 is evaluated. If the convergence criteria 308 have been achieved, then the process continues to step 514 and returns the final mechanical design 324. If the convergence criteria 308 have not been achieved, then the process returns to step 504, and steps 504-512 iterate until the convergence criteria 308 have been achieved.

In sum, the disclosed techniques are directed toward the automated generation of mechanical system designs by combining existing techniques with deep transformer models. More specifically, in various embodiments, a search algorithm is employed to determine an initial sequence of parts for a given system design based on design constraints and an available parts catalog. In some embodiments, multiple possible initial part sequences are proposed. Monte Carlo tree search and estimation of distribution algorithm are both possible choices for the search algorithm, in some embodiments. Subsequently, a deep transformer design model accepts the initial sequence of parts and the design constraints and proposes a complete design solution. In some embodiments, if multiple initial part solutions are proposed, then the deep transformer design model proposes complete design solutions for all proposed initial part sequences, and all possible solutions are returned.

At least one technical advantage of the disclosed techniques over the prior art is that the disclosed techniques combine the strengths of distinct methodologies to address complex mechanical design challenges. Traditional design techniques can be effective at generating a range of candidate solutions, but often struggle to converge on optimal or high-quality solutions when faced with intricate design constraints. In contrast, transformer-based models can generate solutions with exceptional speed, yet often lack the capacity to explore the broader space of creative or unconventional alternatives. The disclosed techniques integrate these complementary capabilities, using the generative efficiency of transformer-based models to rapidly produce candidate solutions while leveraging exploratory methods to more fully traverse the design space. As a result, the techniques can identify and synthesize comprehensive solutions that account for both structural feasibility and design intent. Another technical advantage is the support for interactive and iterative design workflows. By enabling the sampling of complete mechanical system configurations from partially specified inputs, the disclosed techniques allow designers to explore multiple viable design alternatives without restarting the design cycle. This interactivity further enables the real-time incorporation of domain-specific knowledge and user feedback directly into the generative process, leading to more effective, tailored design outcomes.

1. In some embodiments, a computer-implemented method for generating mechanical assemblies comprises: receiving a mechanical parts catalog and assembly requirements for a mechanical assembly; executing an iterative mechanical assembly generation process comprising: generating, via a limited sampling of the mechanical parts catalog, at least one combined mechanical assembly, wherein the at least one combined mechanical assembly potentially satisfies the assembly requirements, generating, via a generative artificial intelligence (AI) model, at least one complete mechanical assembly based on the at least one combined mechanical assembly and the assembly requirements, generating assembly metrics based on at least one physics simulation applied to the at least one complete mechanical assembly, generating a reward score based on the assembly metrics, and repeating the iterative mechanical assembly generation process based on the reward score until a convergence threshold associated with the generative AI model is satisfied; and performing at least one operation associated with the at least one complete mechanical assembly.

2. The computer-implemented method of clause 1, wherein the limited sampling comprises executing at least one of a simulated annealing, a Monte Carlo tree search, or an estimation of distribution algorithm.

3. The computer-implemented method of any of clauses 1-2, wherein the mechanical parts catalog includes a plurality of mechanical parts to be considered based on the assembly requirements for the mechanical assembly.

4. The computer-implemented method of any of clauses 1-3, wherein the at least one operation comprises at least one of transmitting the at least one complete mechanical assembly, displaying the at least one complete mechanical assembly, or modifying the at least one complete mechanical assembly to generate at least one modified complete mechanical assembly.

5. The computer-implemented method of any of clauses 1-4, wherein generating the at least one complete mechanical assembly comprises satisfying at least one of a geometric constraint or a functional constraint defined in the assembly requirements.

6. The computer-implemented method of any of clauses 1-5, wherein generating the reward score comprises applying a weighted scoring function to the assembly metrics based on priorities specified in the assembly requirements.

7. The computer-implemented method of any of clauses 1-6, wherein the at least one physics simulation comprises a stress analysis, a thermal analysis, or a kinematic simulation of the at least one complete mechanical assembly.

8. The computer-implemented method of any of clauses 1-7, wherein the limited sampling of the mechanical parts catalog is constrained by at least one of part availability information, cost threshold information, or material type information.

9. The computer-implemented method of any of clauses 1-8, wherein repeating the iterative mechanical assembly generation process comprises modifying the limited sampling based on the reward score to modify at least one input to the generative AI model.

10. The computer-implemented method of any of clauses 1-9, wherein the convergence threshold comprises a minimum change in reward score across a defined number of consecutive iterations.

11. In some embodiments, one or more non-transitory computer readable media store instructions that, when executed by one or more processors, cause the one or more processors to generate mechanical assemblies, by performing the operations of: receiving a mechanical parts catalog and assembly requirements for a mechanical assembly; executing an iterative mechanical assembly generation process comprising: generating, via a limited sampling of the mechanical parts catalog, at least one combined mechanical assembly, wherein the at least one combined mechanical assembly potentially satisfies the assembly requirements, generating, via a generative artificial intelligence (AI) model, at least one complete mechanical assembly based on the at least one combined mechanical assembly and the assembly requirements, generating assembly metrics based on at least one physics simulation applied to the at least one complete mechanical assembly, generating a reward score based on the assembly metrics, and repeating the iterative mechanical assembly generation process based on the reward score until a convergence threshold associated with the generative AI model is satisfied; and performing at least one operation associated with the at least one complete mechanical assembly.

12. The one or more non-transitory computer readable media of clause 11, wherein the limited sampling comprises executing at least one of a simulated annealing, a Monte Carlo tree search, or an estimation of distribution algorithm.

13. The one or more non-transitory computer readable media of any of clauses 11-12, wherein the mechanical parts catalog includes a plurality of mechanical parts to be considered based on the assembly requirements for the mechanical assembly.

14. The one or more non-transitory computer readable media of any of clauses 11-13, wherein the at least one operation comprises at least one of transmitting the at least one complete mechanical assembly, displaying the at least one complete mechanical assembly, or modifying the at least one complete mechanical assembly to generate at least one modified complete mechanical assembly.

15. The one or more non-transitory computer readable media of any of clauses 11-14, wherein generating the at least one complete mechanical assembly comprises satisfying at least one of a geometric constraint or a functional constraint defined in the assembly requirements.

16. The one or more non-transitory computer readable media of any of clauses 11-15, wherein generating the reward score comprises applying a weighted scoring function to the assembly metrics based on priorities specified in the assembly requirements.

17. The one or more non-transitory computer readable media of any of clauses 11-16, wherein the at least one physics simulation comprises a stress analysis, a thermal analysis, or a kinematic simulation of the at least one complete mechanical assembly.

18. The one or more non-transitory computer readable media of any of clauses 11-17, wherein the limited sampling of the mechanical parts catalog is constrained by at least one of part availability information, cost threshold information, or material type information.

19. The one or more non-transitory computer readable media of any of clauses 11-18, wherein repeating the iterative mechanical assembly generation process comprises modifying the limited sampling based on the reward score to modify at least one input to the generative AI model.

20. In some embodiments, a computer system comprises one or more memories that include instructions, and one or more processors that are coupled to the one or more memories and that, when executing the instructions, are configured to generate mechanical assemblies, by performing the operations of: receiving a mechanical parts catalog and assembly requirements for a mechanical assembly; executing an iterative mechanical assembly generation process comprising: generating, via a limited sampling of the mechanical parts catalog, at least one combined mechanical assembly, wherein the at least one combined mechanical assembly potentially satisfies the assembly requirements, generating, via a generative artificial intelligence (AI) model, at least one complete mechanical assembly based on the at least one combined mechanical assembly and the assembly requirements, generating assembly metrics based on at least one physics simulation applied to the at least one complete mechanical assembly, generating a reward score based on the assembly metrics, and repeating the iterative mechanical assembly generation process based on the reward score until a convergence threshold associated with the generative AI model is satisfied, and performing at least one operation associated with the at least one complete mechanical assembly.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating mechanical assemblies, the method comprising:
receiving a mechanical parts catalog and assembly requirements for a mechanical assembly;
executing an iterative mechanical assembly generation process comprising:
generating, via a limited sampling of the mechanical parts catalog, at least one combined mechanical assembly, wherein the at least one combined mechanical assembly potentially satisfies the assembly requirements,
generating, via a generative artificial intelligence (AI) model, at least one complete mechanical assembly based on the at least one combined mechanical assembly and the assembly requirements,
generating assembly metrics based on at least one physics simulation applied to the at least one complete mechanical assembly,
generating a reward score based on the assembly metrics, and
repeating the iterative mechanical assembly generation process based on the reward score until a convergence threshold associated with the generative AI model is satisfied; and
performing at least one operation associated with the at least one complete mechanical assembly.

2. The computer-implemented method of claim 1, wherein the limited sampling comprises executing at least one of a simulated annealing, a Monte Carlo tree search, or an estimation of distribution algorithm.

3. The computer-implemented method of claim 1, wherein the mechanical parts catalog includes a plurality of mechanical parts to be considered based on the assembly requirements for the mechanical assembly.

4. The computer-implemented method of claim 1, wherein the at least one operation comprises at least one of transmitting the at least one complete mechanical assembly, displaying the at least one complete mechanical assembly, or modifying the at least one complete mechanical assembly to generate at least one modified complete mechanical assembly.

5. The computer-implemented method of claim 1, wherein generating the at least one complete mechanical assembly comprises satisfying at least one of a geometric constraint or a functional constraint defined in the assembly requirements.

6. The computer-implemented method of claim 1, wherein generating the reward score comprises applying a weighted scoring function to the assembly metrics based on priorities specified in the assembly requirements.

7. The computer-implemented method of claim 1, wherein the at least one physics simulation comprises a stress analysis, a thermal analysis, or a kinematic simulation of the at least one complete mechanical assembly.

8. The computer-implemented method of claim 1, wherein the limited sampling of the mechanical parts catalog is constrained by at least one of part availability information, cost threshold information, or material type information.

9. The computer-implemented method of claim 1, wherein repeating the iterative mechanical assembly generation process comprises modifying the limited sampling based on the reward score to modify at least one input to the generative AI model.

10. The computer-implemented method of claim 1, wherein the convergence threshold comprises a minimum change in reward score across a defined number of consecutive iterations.

11. One or more non-transitory computer readable media storing instructions that, when executed by one or more processors, cause the one or more processors to generate mechanical assemblies, by performing the operations of:
receiving a mechanical parts catalog and assembly requirements for a mechanical assembly;
executing an iterative mechanical assembly generation process comprising:
generating, via a limited sampling of the mechanical parts catalog, at least one combined mechanical assembly, wherein the at least one combined mechanical assembly potentially satisfies the assembly requirements,
generating, via a generative artificial intelligence (AI) model, at least one complete mechanical assembly based on the at least one combined mechanical assembly and the assembly requirements,
generating assembly metrics based on at least one physics simulation applied to the at least one complete mechanical assembly,
generating a reward score based on the assembly metrics, and
repeating the iterative mechanical assembly generation process based on the reward score until a convergence threshold associated with the generative AI model is satisfied; and
performing at least one operation associated with the at least one complete mechanical assembly.

12. The one or more non-transitory computer readable media of claim 11, wherein the limited sampling comprises executing at least one of a simulated annealing, a Monte Carlo tree search, or an estimation of distribution algorithm.

13. The one or more non-transitory computer readable media of claim 11, wherein the mechanical parts catalog includes a plurality of mechanical parts to be considered based on the assembly requirements for the mechanical assembly.

14. The one or more non-transitory computer readable media of claim 11, wherein the at least one operation comprises at least one of transmitting the at least one complete mechanical assembly, displaying the at least one complete mechanical assembly, or modifying the at least one complete mechanical assembly to generate at least one modified complete mechanical assembly.

15. The one or more non-transitory computer readable media of claim 11, wherein generating the at least one complete mechanical assembly comprises satisfying at least one of a geometric constraint or a functional constraint defined in the assembly requirements.

16. The one or more non-transitory computer readable media of claim 11, wherein generating the reward score comprises applying a weighted scoring function to the assembly metrics based on priorities specified in the assembly requirements.

17. The one or more non-transitory computer readable media of claim 11, wherein the at least one physics simulation comprises a stress analysis, a thermal analysis, or a kinematic simulation of the at least one complete mechanical assembly.

18. The one or more non-transitory computer readable media of claim 11, wherein the limited sampling of the mechanical parts catalog is constrained by at least one of part availability information, cost threshold information, or material type information.

19. The one or more non-transitory computer readable media of claim 11, wherein repeating the iterative mechanical assembly generation process comprises modifying the limited sampling based on the reward score to modify at least one input to the generative AI model.

20. A computer system, comprising:
one or more memories that include instructions; and
one or more processors that are coupled to the one or more memories and,
when executing the instructions, are configured to generate mechanical assemblies, by performing the operations of:
receiving a mechanical parts catalog and assembly requirements for a mechanical assembly;
executing an iterative mechanical assembly generation process comprising:
generating, via a limited sampling of the mechanical parts catalog, at least one combined mechanical assembly, wherein the at least one combined mechanical assembly potentially satisfies the assembly requirements,
generating, via a generative artificial intelligence (AI) model, at least one complete mechanical assembly based on the at least one combined mechanical assembly and the assembly requirements,
generating assembly metrics based on at least one physics simulation applied to the at least one complete mechanical assembly,
generating a reward score based on the assembly metrics, and
repeating the iterative mechanical assembly generation process based on the reward score until a convergence threshold associated with the generative AI model is satisfied; and
performing at least one operation associated with the at least one complete mechanical assembly.
